(19) United States
(12) Patent Application Publication
(10) Pub. No.: US 2011/0082726 A1
(43) Pub. Date: Apr. 7, 2011

(54) Dual Benefit Gift Card Fundraising System and Method

(76) Inventor: Mark Bower, Waco, TX (US)

(21) Appl. No.: 12/896,694

(22) Filed: Oct. 1, 2010

Related U.S. Application Data
(60) Provisional application No. 61/278,192, filed on Oct. 1, 2009.

(51) Int. Cl. G06Q 99/00; G06Q 30/00

(52) U.S. Cl. 705/14.4

(57) ABSTRACT

The present invention describes a system and method for raising funds for multiple objectives using gift cards. It describes systems and methods for easier, more effective, and more efficient to fundraising for worthy causes, particularly in ways that capitalize on synergies while minimizing waste. The fundraising organization is able to raise funds for its own operations while at the same time providing benefits to other organizations such as small artisan co-ops. The fundraising system and method is directed to the object of providing a regular captive market and efficient distribution opportunity for artisan co-ops in impoverished societies by creating an incentive structure for raising funds through schools and school-related activities or the like.

### CROSS REFERENCES TO RELATED APPLICATION

The present application claims the benefit of prior filed U.S. Provisional Application, Ser. No. 61/278,192, filed Oct. 1, 2009. By this reference, the full disclosure, including the drawings, of U.S. provisional application Ser. No. 61/278,192 is incorporated herein as though now set forth in its entirety.

### BACKGROUND OF THE INVENTION

1. Technical Field

Many aspects of this invention relate generally to fundraising systems and methods and, more particularly, to comprehensive systems and methods for simultaneously raising funds for cooperative organizations of multiple different kinds. Some aspects of the invention may also relate to the gift cards, catalogs, screen displays, software programs, software storage media, web applications, and related machines, components, articles and methods associated with such fund raising systems and methods.

2. Related Art

There is always a need to find successful ways to raise funds with virtually any worthy cause, not the least of which is supporting impoverished societies on the one hand, or school-related activities on the other. Impoverished societies are in desperate need of help, but it is difficult to find a workforce that can help them on a volunteer basis. Extracurricular school activities, on the other hand, are often able to capitalize on the ready force of volunteer fund-raisers that can be found in the student body of the school or school-related organization. Both of these types of causes need fundraisers, and both need systems and methods to facilitate the same.

### SUMMARY OF THE INVENTION

It is a primary object of the present invention to improve upon the prior art and to make it easier, more effective, and more efficient to raise funds for worthy causes, particularly in ways that capitalize on synergies while minimizing waste. Within such general objects, the present invention is directed to the object of providing a regular captive market and efficient distribution opportunity for artisan co-ops in impoverished societies by creating an incentive structure for raising funds through schools and school-related activities or the like.

While there are many alternative variations, modifications and substitutions within the scope of the invention, one of ordinary skill in the art should consider the scope of the invention from a review of any claims that may be appended to any application based on this filing (including any amendments made to those claims in the course of prosecuting this and related applications), while the same should be considered in the context of the prior art and the various descriptions of this application. Many other objects, features and advantages of the present invention will be evident from the remainder of this application in light of a more exhaustive understanding of the numerous difficulties and challenges faced by the prior art, as will be evident to those skilled in the art.

### BRIEF DESCRIPTION OF THE SEVERAL VIEWS OF THE DRAWINGS

For a more complete understanding of the present invention and its preferred embodiments, and the advantages thereof, reference is now made to the following descriptions taken in conjunction with the accompanying drawings, in which:

FIG. 1 is a schematic block diagram of the various participant entities and transferred objects making up the system and method of the present invention.

FIG. 2 is a partially schematic plan view of a typical gift card sales packet of the present invention before distribution.

FIG. 3 is a schematic view of the electronic database (EDB) components of the system of the present invention including the school administration EDB and the broker EDB.

FIG. 4 is a flowchart of the steps of the method of the present invention associated with establishing and setting up the dual benefit fundraising program.

FIG. 5 is a flowchart of the steps of the method of the present invention associated with the sale, distribution and use of the gift cards of the dual benefit fundraising program.

FIG. 6 is a flowchart of the steps of the method of the present invention associated with gift card purchase fulfillment and distribution of the proceeds from the dual benefit fundraising program.

### DETAILED DESCRIPTION OF PREFERRED EMBODIMENTS

The present invention provides a system and method for implementing a dual benefit gift card fundraising program. One goal of the present invention is to provide a process whereby a fundraising organization is not only able to raise funds for its own operations and charitable endeavors, but at the same time is able to provide a benefit to small artisan co-ops and the like that might otherwise not have access to profitable markets. The overall system described herein below comprises a fundraising environment most applicable to school-related organizations are commonly connected or associated with an administration or other form of governing body. At the opposite end of the fundraising environment of the present invention are small artisan groups that, without the assistance of the system and method of the present invention, might find it difficult, if not impossible, to sell their products for a fair and reasonable profit. It is anticipated that other types of organizations beyond these specifically addressed herein could likewise implement the system and method described. Some components of the system and some steps in the method are therefore directed primarily to a school administration and student organization environment. Nonetheless, those skilled in the art will recognize a manner in which such system components and method steps could easily translate into alternate organizational environments with the same basic program structure.

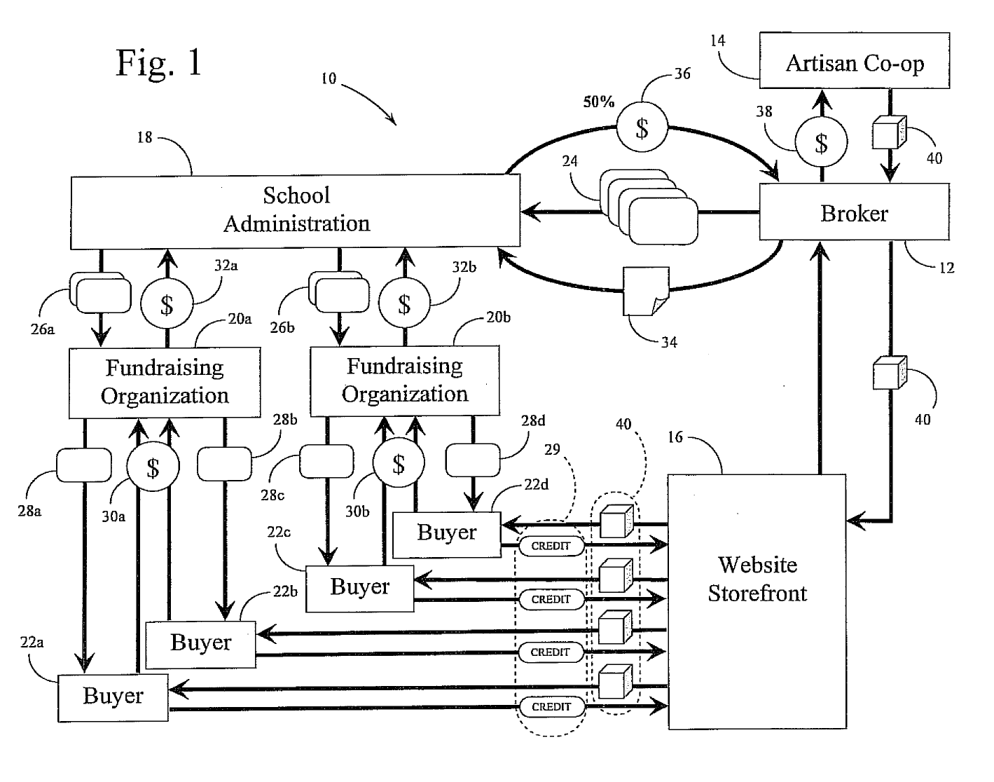

FIG. 1 is a schematic diagram that provides an overview of the various participant entities and transferred objects that make up the system and method of the present invention. This schematic view in FIG. 1 is intended to provide an overview of the various participants and their relationships with each other in the transfer of monies, products, and program components as necessary for the implementation of the methods and processes of the invention. The dual benefit program environment 10 shown in FIG. 1 shows the primary participants as including program broker 12 and one or more associated artisan groups or co-ops 14. Program broker 12 is the entity that is primarily responsible for carrying out the necessary data processing and handling of information associated with the program process. Artisan co-op 14 may be a representative underserved product manufacturing individual or group that, for various reasons, may not have easy access to profitable markets for the sale and distribution of its products. Artisan co-op 14 may, for example, be a small business in a less developed country that, without going through a more generous low profit products broker, would not be able to obtain an adequate or appropriate financial return on the sale of its products. It is not uncommon for a typical products broker handling artisan type products from small groups or individuals in foreign countries, to pay those sources of artisan products a very small percentage of the final sales price for the product (the price paid by the purchasing consumer in the more developed countries). The present invention has in part an objective to provide such access to these artisan co-ops by creating an incentive structure for raising funds and making connections between buyers and the artisan co-ops, without the need to go through a high mark-up brokerage business.

Also shown in FIG. 1 are the fundraising organization participants in the system of the present invention associated initially with a connection between broker 12 and school administration 18. School administration 18 in turn has associated with it one or more student fundraising organizations 20a-b as are typically found at pre-schools, elementary schools, junior high schools, high schools, colleges, and universities or similar organized bodies of people. It is not uncommon for such student organizations to raise funds for their own operations throughout the school year, as well as to raise funds for charitable donations to outside organizations.

Broker 12, as positioned within the overall environment and structure of the system of the present invention shown in FIG. 1, is further responsible for the establishment, maintenance, and operation of website storefront 16. Provided as the primary, if not the only, outlet for the products created by artisan co-op 14, website storefront 16 is a critical component in the ability of the system to carry out the method described wherein gift cards become the exchange currency associated with the sale and delivery of products manufactured by artisan co-op 14. Broker 12 is therefore responsible not only for the set-up of website storefront 16 but also the authorization of credits 29 that are used to purchase products 40 through the website storefront, and finally for the shipping and delivery of these products through the website storefront to the ultimate buyers. It should be recognized that website storefront 16 can be used as an alternate outlet for an existing store, such as for an existing supermarket, and may itself be embodied as a physical storefront rather than a website storefront in alternative embodiments.

An important physical component of the present invention associated with carrying out the functionality of the system and method of the program is a gift card sales packet component. A bundle of these is represented in FIG. 1 as gift card sales packet bundle 24 which is prepared by broker 12 and transferred over to school administration 18. Such transfer of gift card sales packet bundle 24, or the application of a label for a particular student organization, may be the initial step in the process of implementing the fundraising program. From school administration 18 individual gift card sales packets 26a-b are distributed to school fundraising organizations 20a-b. A further critical element in this process involves the scanning of bar codes associated with the gift card sales packets, as is described in more detail below.

Student fundraising organizations 20a-b are shown in FIG. 1 as directing the sale of individual gift cards 28a-d to buyers 22a-d. The number of student organizations and buyers shown in FIG. 1 is of course merely representative of any number of student organizations and buyers, as well as any number of gift card packets and individual gift card sets. Provided by way of example in FIG. 1 are but two student fundraising organizations, and in each case two distinct buyers associated with purchases of one gift card a piece. It is anticipated that operations of such a system would involve much larger numbers of student organizations and of course, much larger numbers of buyers purchasing one or more individual gift cards. The basic program structure shown in FIG. 1 however, is intended primarily to describe the relationships between the various entities in carrying out the processes associated with the program of the present invention.

The individual buyers 22a-d pay money (typically in the form of cash, checks, debit card, or credit card payments) to the student fundraising organizations 20a-b shown in FIG. 1, in the form of monetary receipts from buyers 30a-b. Student fundraising organizations 20a-b then pass these money receipts 30a-b back to school administration 18 in the form of money receipts 32a-b that are either paper or electronic receipts or tabs from sold gift cards. School administration 18 accounts for not only the gift card sales packets distributed but also the monies returned from the student fundraising organizations. In the process of making this accounting, school administration 18 communicates this data (preferably electronically) to broker 12 as described in more detail below. Broker 12 then generates invoice 34 from broker 12 to school administration 18. School administration 18 then makes payment 36 on the invoice, which in the preferred embodiment may represent 50% of the funds ultimately received from buyers 22a-d in the form of payments 30a-b.

Buyers 22a-d utilize gift cards 28a-d and the codes contained thereon, as paid-for credit mechanisms for use in conjunction with website storefront 16. The gift card credits 29 associated with the gift cards received by the buyers may be used at the website to purchase products. Before these products may be purchased, broker 12 must authorize the gift card credits 29 by identifying the code numbers as having been activated through the receipt of monies from the buyer through the school administration. This authorization process is preferably performed through the use of a USB scanner that reads the code from the tabs remaining from sold gift cards. After activation, the gift card code numbers may then be used by the buyers to purchase products. The administration site will then be able to ascertain whether particular cards are activated and can determine whether to hold or ship based on that status of a particular card. In the event an ultimate customer places an order without paying for the card (or without the tab from the card being scanned as activated), then the system will not allow the product to be shipped. A small percentage of payment 36 from school administration 18 may be retained by broker 12 in the process of making such payments 38 to artisan co-ops 14. The retention is, as indicated, a small percentage for the purposes of administering website storefront 16 and carrying out the necessary shipping and delivering of products 40 under the program.

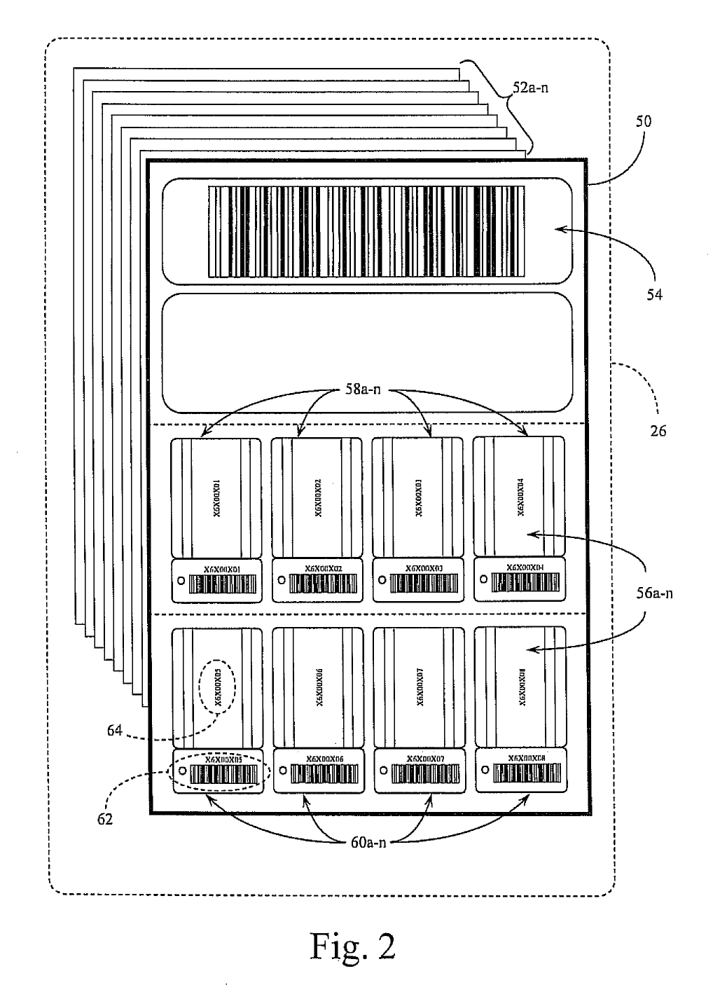

Reference is now made to FIG. 2 for a description of a partially schematic view of a typical gift card sales packet of the present invention as it might appear prior to distribution to the student fundraising organizations. Gift card sales packet 26 shown in FIG. 2 is primarily made up of gift card packet card sheet 50 and a number of product catalogs 52a-n. Such gift card sale packets 26 preferably are distributed on a ring that holds the tabs of multiple sheets in the packet together after the gift cards are detached (each sheet preferably containing approximately 10 gift cards that can be detached from the sheet along perforated lines). In the example shown in FIG. 2 the packet is set-up to contain enough materials for distribution to eight separate buyers providing eight catalogs and eight different gift card sets. It is anticipated that the number of buyers intended to be covered by a single packet could vary based upon the type of fundraising and the group of consumers towards which the gift cards are directed. In the preferred embodiment, any number from six to a packet, to twelve to a packet, may be appropriate for distribution to individual students within a student fundraising organization. Such numbers allow a group of gift cards to be consolidated into a single packet for efficient processing while still allowing for partial sales or a small number of sales from an individual gift packet. In the preferred embodiment it is desired that an individual student might, for example, completely sell gift cards within a single packet that may be provided, and as a result, the number of buyers associated with a single packet could vary depending upon the type of student organization or the type of school to which the packets are directed (a small high school on up to a large university, for example). Alternatively, an individual card from a packet can be sold, the packet returned, and the remaining cards re-used such that the sold card(s) remain credited on-line to the active group that sold it.

Catalogs 52a-n are preferably print catalogs that provide all or a representative sample of the products provided for purchase on the Internet website storefront established by the broker as described above. The use of catalogs 52a-n in the gift card sales packet 26 is important because it anticipates that the process of selling gift cards to individuals will initially occur not on-line where potential buyers would have been able to review the products for sale, but in person such that the student may present the catalog of products for review to encourage the sale of the gift card. Various guidance information for the student seller of the gift card set may be provided within packet 26 to facilitate the promotion and sale of the gift cards in association with the promotion and sale of the products represented under the program.

Gift card packet card sheet 50 includes an identifying packet bar code 54. This bar code 54 is utilized in the method of the present invention at a number of stages of the process in order to make possible the efficient accounting of gift cards distributed and monies received. It is through the scanning of this packet bar code 54 and the bar codes associated with the gift card tracking receipts that the handling of the gift cards, the monetary funds paid for the gift cards, and the confirmation of credit available to the buyers at the website storefront, are all made more efficient so as to reduce the overall administrative costs associated with carrying out the process of the program. As one goal of the program is to direct a majority of the funds to the fundraising organizations and to the original product manufacturing artisan groups, every effort is made to improve the efficiency of the administration of the program throughout. The use of bar code 54 associated with each individual packet, bar code/ID code 62 (described in more detail below) associated with each individual card set, as well as other steps in the process, are all directed towards creating this optimal efficiency and reduction in administrative costs.

Also associated with gift card packet card sheet 50 are a number of gift card sets 56a-n that are typically positioned on the card sheet 50 in a manner that they may be individually removed at the time of sale. Each gift card set 56a-n is made up of gift cards 58a-n and card tracking receipts 60a-n. On each gift card 58a-n is a gift card ID code 64 that is utilized by the buyer of the gift card to obtain and spend credits made available on the website storefront. Gift card ID code 64 matches (in some part) with tracking receipt bar code/ID code 62 on card tracking receipt 60a-n. When a gift card set 56a-n is removed from gift card packet card sheet 50 and sold to the buyer, the gift card 58a-n is detached from the card tracking receipt 60a-n with the gift card being distributed to the buyer and the student seller retaining the card tracking receipt 60a-n. In this manner the student need not specifically record any other information associated with the gift card transaction. The appropriate information necessary for activating or confirming activation of the gift card on the website storefront is provided by way of the bar code/ID code. In the preferred embodiment, the packet ID bar code will include a code element that is common to each of the individual gift card sets included in the packet. In other words, each gift card set (gift card and card stub/receipt) will be immediately identifiable as associated with a particular packet and therefore may be associated with a particular student organization or specific student, if need be.

As described in more detail below, the student seller of the gift card will return the collection of card tracking receipts 60a-n representing sold gift cards back through the system in order to associate the purchase with the credit available to the buyer at the website storefront. Of course, the student seller receives and initially retains the money in payment from the buyer for the amounts associated with the gift card. In the preferred embodiment it is anticipated that some fixed monetary amount be associated with each gift card, so as to prevent any modification or customized recordal of the amounts received and the level of gift card credit. In preferred embodiments, a $10 or $20 gift card would most likely be appropriate as the nominal denomination of the gift card with multiple purchases by the buyer being anticipated in order to receive a higher total website credit. Here again, alternate types of student organizations or alternate types of schools might prefer to receive smaller or larger gift card denominations depending on the buyer/customer environment to which they anticipate the gift card sales will be directed. Gift cards in a denomination as small as $5 may be anticipated with alternate consumer environments meriting as much as a $50 gift card denomination.

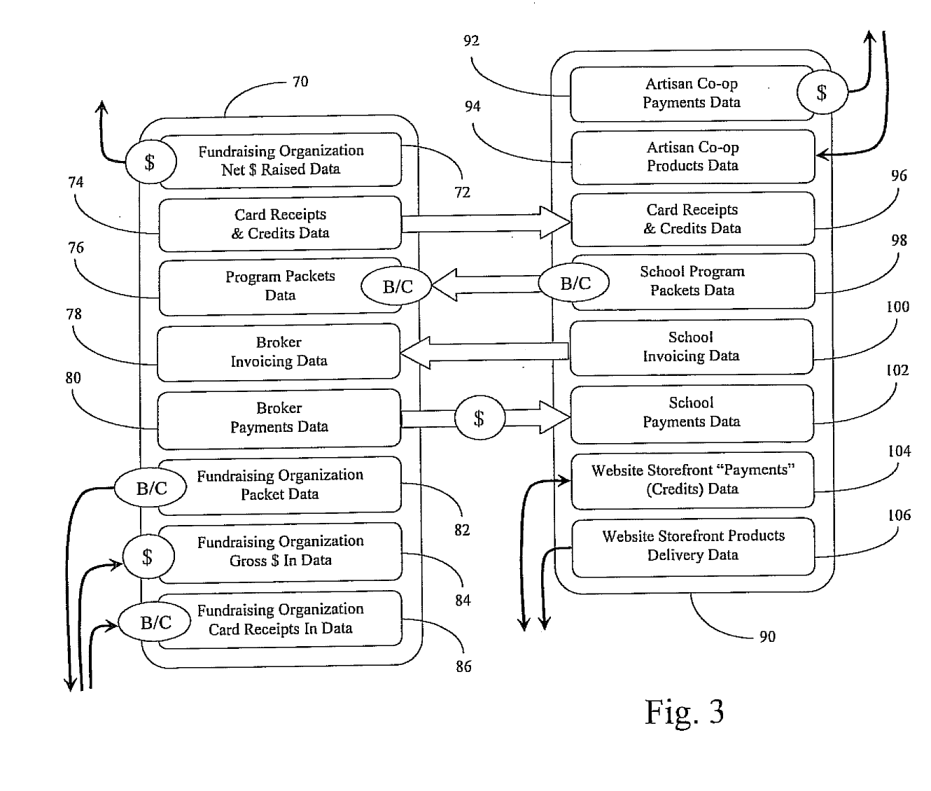

Reference is now made to FIG. 3 for a description of the electronic data processing (EDP) that occurs in conjunction with the system and method of the present invention, and which in particular is facilitated by the use of the above described bar coded packets and gift cards. In the system of the present invention, as shown generally in FIG. 1, two of the primary participants are responsible for maintaining an electronic database (EDB) and for carrying out electronic data processing (EDP) associated with information involved in the various transactions that occur. Broker 12 will generally maintain broker electronic database (EDB) 90 and school administration 18 will generally be required to maintain school administration electronic database (EDB) 70. It is, of course, anticipated that the requirements for these electronic databases and the processing capabilities required for each, are no more stringent than what most school administrations would normally have available to maintain records and to account for their own financial transactions. Likewise, the broker in the program of the present invention is easily established to maintain the website storefront will thereby typically include electronic data processing facilities sufficient to carry out the record keeping and the handling of all of the various other functions and processes associated with the program.

As shown in FIG. 3, school administration EDB 70 is structured with a number of database components that might be manipulated and/or receive input and provide output during the operation of the method of the present invention. Initially, this database processing may be considered to include the recordal of the receipt of program packets data 76 by way of one or more scanned bar codes (B/C) resulting from the physical transfer of the program packets to the school administration from the broker. Program packet data 76 in turn provides the basic information that is later processed in association with student organization packet data 82. As the gift card packets are distributed to the student fundraising organizations the bar codes are again scanned and thereby allow organization packet data 82 to serve as a more specific organization based record keeping mechanism. This may thereafter provide output to the student fundraising organizations if in fact separate organization record keeping mechanisms are being utilized.

As money is returned by the student fundraising organization it is entered into the school administration EDB 70 through fundraising organization gross money receipts in EDB component 84. At the same time, information associated with the bar codes (B/C) on each of the gift card tracking receipts is scanned and re-enters the school administration EDB 70 in the form of fundraising organization card receipts data 86. As the information is scanned and received into fundraising card receipts data 86 the information is simultaneously transferred electronically to the broker in the program. Data is then transferred from the broker (as described below) and is received into the school administration EDB 70 at EDB component 78 representing broker invoicing data. Broker payments data is represented in EDB component 80 which contains information that will authorize and direct the transfer of funds to the broker based upon the invoiced amounts. Also included in the process of transferring data to the broker are changes in the card receipts and credit data EDB component 74. At the same time this information provides the basis for the broker to invoice the school administration, the data also provides the basis for the broker to authorize the appropriate credits at the website storefront.

Finally, within school administration EDB 70, a database component associated with maintaining information on the fundraising organizations net money raised is provided in EDB component 72. This database component 72 represents the amounts that each of the individual student fundraising organizations returned in the way of monetary sales, a portion of which is distributed back from the school administration (preferably by a simple electronic account transfer) to the student organizations for their use.

The other side of the electronic database structure shown in FIG. 3 is represented by broker electronic database EDB 90. Specific database components of broker EDB 90 are directly associated with input and output to and from the school administration EDB 70 as shown. Initially, school program packets data 98 is established, again typically by way of scanning the bar codes associated with each of the gift card packets and packet bundles. These bundles are then transferred to school administration whereby program packets data 76 becomes resident in the school administration EDB 70 and should correspond directly with school program packets data 98 resident in the broker EDB 90. When card receipts and credit data 74 is established in the school administration EDB 70 it is simultaneously transferred through electronic communication to broker EDB 90 to alter credit receipts and credits data EDB component 96. This information then alters school invoicing data 100 which represents the basic data component responsible for generating the invoice to be sent back to the school administration. When payments are received from the school administration, school payments data component 102 is updated and altered.

Broker EDB 90 likewise includes database components associated with the operation of the website storefront as well as database components associated with the business relationship with the artisan co-ops. Website storefront payments (credits) database component 104 involves I/O data communication with the website storefront, authorizing the credits such that they may be spent by the buyers, and likewise receiving data back indicating that the buyers have utilized the credits to order product. Website storefront products delivery data EDB component 106 maintains the necessary information to carry out the fulfillment of the orders made by the buyers and to provide shipping and handling of the product back to the buyer either from product inventory or from direct purchases from the artisan co-ops.

Finally, broker EDB 90 includes database components associated with the receipt of products and the payment for such products to the artisan co-ops or individual artisans. Artisan co-ops payment data 92 represents data associated with the ongoing financial transactions involving payments to the co-ops by the broker, while artisan co-ops product data 94 represents data associated with the ongoing ordering, handling, shipping, and delivery of products from the artisan co-ops into a broker managed warehouse or directly to the buyers as purchased from the website storefront.

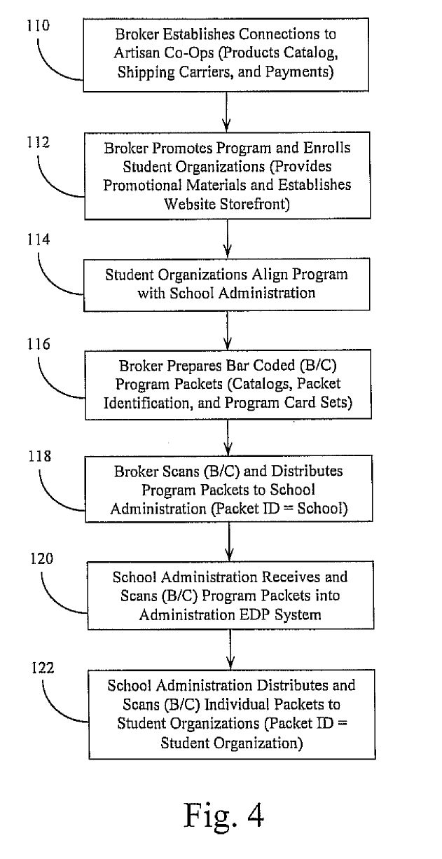

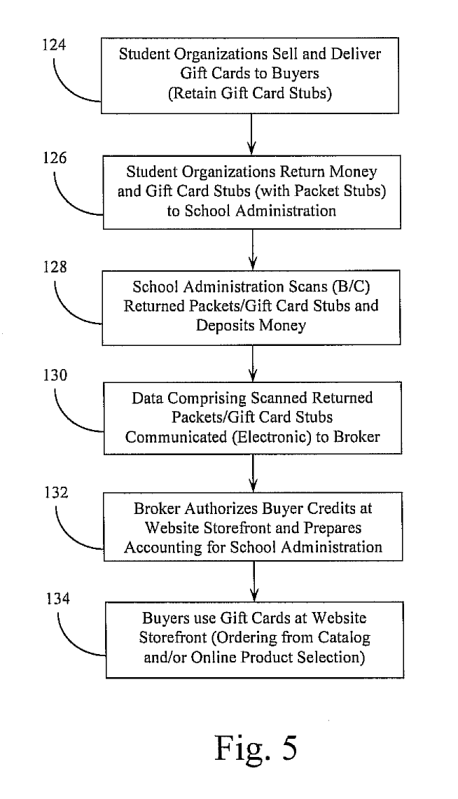

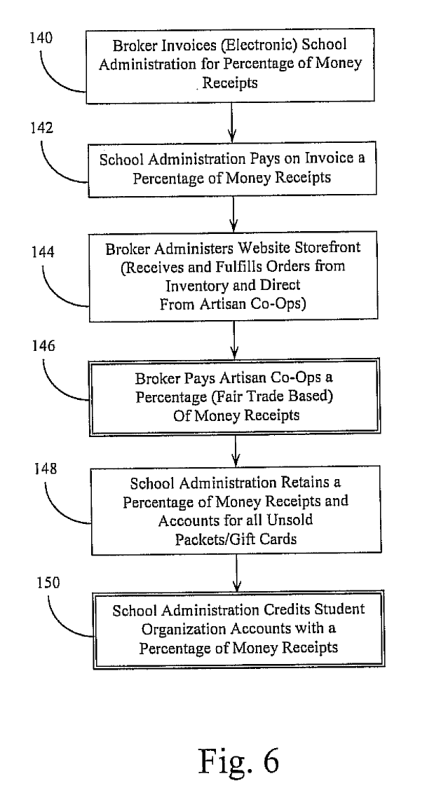

Reference is now made to FIGS. 4-6 for a description of the basic method steps associated with the operation of the program of the system of the present invention. The overall process, which is facilitated and made possible through the use of the bar coded gift card packages, the coded gift cards, and the specific electronic data processing carried out by the school administration EDP and the broker EDP, may generally be divided into three parts represented in each of the three figures, FIGS. 4-6. FIG. 4 represents the basic steps associated with establishing the participants in the program and creating/distributing the gift card program packets to the schools and school student organizations. FIG. 5 represents steps in the method of the present invention generally associated with the sale, distribution, and use of the gift cards of the dual benefit fundraising program from the student organizations (as sellers) to the gift card buyers. Finally, FIG. 6 is a flowchart of the steps of the method of the present invention associated with gift card purchase fulfillment as well as the distribution of the proceeds from the dual benefit fundraising program as carried out by the broker and the school administration.

The initial program establishment method steps shown in FIG. 4 begin at Step 110 with the broker establishing connections to the artisan co-ops that will participate in the product fulfillment portion of the program. As indicated above, these artisan co-ops could represent anything from individual artisans to large groups of artisans for particular products or from particular geographic regions. The broker would preferably carry out the various necessary negotiations and establishment of contracts for the purchase of products and the corresponding payment back to individual artisans or artisan co-ops. In addition, at Step 110, the broker produces product catalogs, establishes shipping carriers, and defines the financial transaction mechanism to effect payments to the artisan co-ops. At Step 112 the broker promotes the program and enrolls the various student organizations within various schools, colleges, and universities. In this Step 112 the broker provides the promotional materials and establishes the website storefront to carry out the various further activities within the program process.

Step 114 in the process shown in FIG. 4 involves having the student organizations align the program with school administration. It is anticipated that Step 114 may occur prior to or at the same time as Step 112 wherein the broker may approach a school as a whole or may promote its program directly to individual student fundraising organizations, who in turn seek authorization and acceptance of the program by school administration. In any event, it is necessary that the school administration sign onto the program as its electronic data processing system is a necessary component in the operation of the program method. It is anticipated that the school administration will have or will be provided with the necessary electronic data processing hardware required to carry out the program. In particular, setting up the school administration may involve the provision of a bar code scanner that the school administration will use to facilitate the tracking of the various gift card packets and individual gift card tracking receipts as described above.

Once the student organizations and school administration participants have been established, the broker prepares, at Step 116, the bar coded program packets which include the catalogs, the packet identification (bar code) and the above described program gift card sets. The broker then scans, at Step 118, the various program packets or packet bundles, and distributes these to the school administration, associating a particular scanned packet ID with a particular school. It is not necessary from the broker's standpoint that the packet ID be associated with a particular student organization, only that a particular school be identified as the recipient of that particular gift card packet or packet bundle. At Step 120 the school administration receives the program packets and scans the bar codes associated with each of the packets into the school administration EDP system. Alternatively, such bar code scanning may be eliminated in the event that the login to the EDB system via the internet already accounts for such, in which case the administration serves principally as the distributor for products. Finally, at Step 122, the school administration distributes (and preferably again scans the bar codes) the individual packets to each of the student fundraising organizations. At this point, each packet ID (as provided on the packet bar code) is associated with a specific student fundraising organization. This tracking step, once again, is for school administration record keeping purposes and is not specifically material to the broker EDP information.

As indicated above, FIG. 5 represents the steps in the method of the present invention wherein the individual gift cards are sold and distributed to the buyers as the primary financial transaction in the dual benefit fundraising program. At Step 124 the student organizations sell and deliver the gift cards to the buyers while retaining the gift card tracking stubs/receipts as described above. In the process, the individual students within the student organizations receive and initially retain the money from the buyers that is associated with the purchase of the standard denomination gift cards. At Step 126 the student organizations return the money and the gift card tracking stubs (along with the original packet card sheets having the packet ID bar codes thereon) to the school administration. The school administration, at Step 128 scans the bar codes associated with the returned packets and gift card tracking stubs and deposits the monies received in association with the gift card sales into its operating accounts.

As the school administration scans the bar codes and records the monies received at Step 128, the data comprising the scanned returned packets and gift card tracking stubs is communicated electronically at Step 130 to the broker. This allows the broker, at Step 132 to authorize the buyer credits at the website storefront and prepares the necessary accounting to be delivered to the school administration. This accounting involves the invoicing described above and thereafter the payment by the school administration based on the invoicing. Finally, at Step 134, the buyers that have purchased the gift cards use the gift card credits at the website storefront, ordering from the catalog that they may have received in the process of purchasing the gift card and/or from the online product selection that is available at the website storefront. The website storefront allows the order to be entered at any time, but is cleared to ship only after the school administration has scanned the gift card tabs.

Reference is finally made to FIG. 6 for a description of the gift card purchase fulfillment procedures as well as the final steps involved in the distribution of the fundraising proceeds that derive from the dual benefit fundraising program. In Step 140 shown in FIG. 6, the broker invoices (preferably electronically) the school administration for a fixed percentage of the money receipts accounted for and communicated to the broker by the school administration. In the preferred embodiment, a 50% share of the total money receipts acquired by the various student fundraising organizations and accounted for by the school administration, may be directed back to the schools (kept by the schools) with the same percentage (the balance) being directed to the broker, primarily for eventual payment to the artisan co-ops. At Step 142 the school administration pays on the invoice it receives from the broker this 50% share of the money receipts.

As part of (prior to or subsequent to) the receipt of monies and the invoicing of the school administration, the broker administers, at Step 144, the website storefront wherein it receives and fulfills orders from the buyers, either out of warehoused inventory or direct orders from the artisan co-ops. In the preferred embodiment, the broker maintains a sufficient warehouse inventory of artisan co-op products, that immediately upon activating the web store credit, based upon the gift cards sold, individual buyers may purchase product and anticipate a reasonable delivery time through the activities of the broker and its administering the fulfillment of the orders.

At Step 146 one of the two primary goals of the program of the present invention is achieved wherein the broker pays the artisan co-ops a primary percentage (a fair trade based quantity or amount) of the money receipts from the school administration for the products that the artisan co-ops have produced and the broker has shipped to the buyers. Once again, it is anticipated that these payments may actually precede the ordering of product by the individual buyers and may represent payments in advance for products received into warehoused inventory by the broker.

At Step 148 the school administration is shown once again to retain a percentage of the money receipts and in the process will account for all unsold packets and gift cards. This accounting carried out by the school administration provides the basis for effecting the second of the two primary goals of the fundraising program of the present invention, whereby at Step 150 the school administration credits the various student organization accounts with a pro rata percentage of the money receipts as their share of the fundraising efforts. It is the second benefit, whereby the student organizations are able to secure operational funds for their various activities during the school year, and at the same time provide benefit to the artisan co-ops by serving as distributors into a new market not normally available to the artisan co-ops, that provides the unique dual benefit aspect to the program system and method of the present invention.

Although the present invention has been described above in connection with a particular organizational environment, it is anticipated that other organizational environments (other than a school based fundraising environment) could just as easily adopt the basic principles of the system and method to effect a similar dual benefit. Those skilled in the art will also recognize that certain modifications to the numbers and percentages given in the above as examples will be appropriate for other fundraising environments and other levels of buyer markets. Such modifications are anticipated to remain within the spirit and scope of the present inventive system and method. The goal of providing monetary rewards to deserving organizations while minimizing the overhead costs associated with carrying out the transactions is achieved primarily through the use of rapid tracking mechanisms (such as the bar codes) and the rapid accounting that can be achieved through the primary participant data processing systems. Alternate mechanisms for coding the various transferrable components within the program system are also anticipated. Substituting magnetic strips for bar codes and magnetic card readers for the bar code readers may provide the same or a similar efficiency to the system. Other modifications to the system and method described herein will be apparent to those skilled in the art, which modifications still fall within the scope of the invention.

Still other embodiments of the invention relate to application-specific machines that incorporate software to achieve the methods according to the teachings reflected herein, as well as subsystems, macrosystems or methods for performing all or part of the processes described or inferred herein. While there are many variations within the scope of the invention, one of ordinary skill in the art should consider the scope of the invention from a review of any claims appended hereto (including any amendments made to those claims in the course of prosecuting this and related applications) as considered in the context of the prior art and the various descriptions of this application.

Numerous variations, substitutions, modifications and simplifications will still fall within the scope of the inventions that are the subject of this application. Many other features, benefits and advantages of the inventions related to the embodiments referenced herein will be evident to those of skill in the art in light of an exhaustive review of the prior art. Even though the foregoing embodiments represent the most preferred at present, those of ordinary skill in the art will recognize many possible alternatives that we have not expressly suggested here. While the foregoing written descriptions enable one of ordinary skill to make and use what is considered presently to be best modes of the invention, those of ordinary skill will understand and appreciate the existence of variations, combinations, and equivalents of the specific embodiment, method, and examples herein. It should be understood that the drawings and detailed descriptions herein are to be regarded in an illustrative rather than a restrictive manner, and are not intended to limit the invention to the particular forms and examples disclosed. To the contrary, the invention includes any further modifications, changes, rearrangements, substitutions, alternatives, design choices, and embodiments apparent to those of ordinary skill in the art, without departing from the spirit and scope of this invention, as defined by any claims included herewith or later added or amended in an application claiming priority to this present filing. The invention covers all embodiments within the scope and spirit of such claims, irrespective of whether such embodiments have been remotely referenced here or whether all features of such embodiments are known at the time of this filing. Thus, it is intended that the claims be interpreted to embrace all further modifications, changes, rearrangements, substitutions, alternatives, design choices, and embodiments that may be evident to those of skill in the art. In any case, all substantially equivalent systems, articles and methods should be considered within the scope of the present invention.

I claim:

1. A method for raising funds for multiple objectives using gift cards, comprising:
a. establishing and maintaining a first electronic database comprising information on a gift card program;
b. creating gift cards with gift card information comprising:
(1) a website address for a website storefront,
(2) a unique identification code for said gift card,
(3) a face value for said gift card;
c. promoting said gift card program for the sale of said gift cards in a manner that addresses a primary mission;
d. operating said website storefront to offer sale of products in a manner that addresses a secondary mission; said website being operated to accept said gift cards as payments for said products;
e. providing a school administration with said gift cards;
f. providing said school administration with capability to monitor and control the distribution of said gift cards to a fund raising organization;
g. enabling said fund raising organization to sell said gift cards to buyers;
h. receiving funds from said school administration for sales of said gift cards;
i. activating said gift cards for use in purchasing products through said website storefront;
j. crediting said school administration with a percentage of funds received from said buyers; and
k. authorizing said purchased products to be shipped from said website storefront to recipients designated by said gift card buyers upon verification of activation of said gift cards.
